(19) United States
(12) Patent Application Publication
(10) Pub. No.: US 2024/0407021 A1
(43) Pub. Date: Dec. 5, 2024

(54) COMMUNICATION APPARATUS, METHOD, AND STORAGE MEDIUM FOR STORING A PROGRAM

(71) Applicant: CANON KABUSHIKI KAISHA, Tokyo (JP)

(72) Inventor: KOHEI YAMADA, Kanagawa (JP)

(21) Appl. No.: 18/677,089

(22) Filed: May 29, 2024

(30) Foreign Application Priority Data
May 29, 2023 (JP) 2023-088071

(51) Int. Cl. H04W 76/10; H04W 12/06; H04W 28/06

(52) U.S. Cl. CPC H04W 76/10; H04W 12/06; H04W 28/06

(57) ABSTRACT

A communication apparatus includes: a holding control unit configured to perform control such that a holding unit holds information to be used for communication for establishing a wireless connection according to a first connection method between an external access point and the communication apparatus; a reception control unit configured to perform control so as to receive a request transmitted from an information processing apparatus based on the held information; a communication control unit configured to perform control so as to execute communication for establishing the wireless connection according to the first connection method based on the request received by the reception control unit; and a discarding control unit configured to perform control so as to discard the information held in the holding unit based on the reception control unit having received the request.

### BACKGROUND

### Field

The present disclosure relates to a communication apparatus capable of establishing a wireless connection with an external apparatus, a method, and a storage medium storing a program.

### Description of the Related Art

Techniques in which an information processing apparatus, such as a personal computer (PC), transmits information related to an access point to a communication apparatus, such as a printer, and in that way connects the communication apparatus and that access point are known. For example, Wi-Fi Alliance has standardized a mechanism for transmitting and receiving network information between devices called Wi-Fi Easy Connect (WEC), which uses Device Provisioning Protocol (DPP). In WEC, QR Code®, Bluetooth Low Energy (BLE), near field communication (NFC), and the like are given as examples of a configuration of Bootstrapping that triggers transmission and reception of network information, and communication is started by providing a public key to a device to be a communication partner. Japanese Patent Laid-Open No. 2019-180036 discloses displaying Bootstrapping information using a QR code.

### SUMMARY

There is a need to further improve security in a function for connecting a communication apparatus and an access point.

The present disclosure provides mechanisms and techniques for further improving security in a configuration for connecting a communication apparatus and an access point.

Various embodiments of the present disclosure concern a communication apparatus capable of communicating with an information processing apparatus. The communication apparatus includes at least one memory and at least one processor which function as: a holding control unit configured to perform control such that a holding unit holds information to be used for communication for establishing a wireless connection according to a first connection method between an external access point and the communication apparatus, the access point being different from both the information processing apparatus and from the communication apparatus; a reception control unit configured to perform control so as to receive a request transmitted from the information processing apparatus based on the held information; a communication control unit configured to perform control so as to execute communication for establishing the wireless connection according to the first connection method based on the request received by the reception control unit; and a discarding control unit configured to perform control so as to discard the information held in the holding unit based on the reception control unit having received the request.

According to various embodiments of the present disclosure, it is possible to further improve security in a configuration for connecting a communication apparatus and an access point.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a system according to one embodiment.

FIG. 2 is a diagram illustrating an external configuration of a communication apparatus according to one embodiment.

FIGS. 3A, 3B and 3C are diagrams illustrating user interface screens to be displayed on the communication apparatus according to one embodiment.

FIG. 4 is a diagram illustrating a configuration of the communication apparatus according to one embodiment.

FIG. 5 is a diagram illustrating an external configuration of an information processing apparatus according to one embodiment.

FIG. 6 is a diagram illustrating a configuration of the information processing apparatus according to one embodiment.

FIG. 7 is a diagram illustrating a configuration of an external access point according to one embodiment.

FIG. 8 is a sequence diagram illustrating processes between the apparatuses according to one embodiment.

FIG. 9 is a flowchart for explaining processing to be executed in the communication apparatus according to one embodiment.

FIG. 10 is a sequence diagram illustrating processes between the apparatuses according to one embodiment.

FIG. 11 is a flowchart for explaining processing to be executed in the communication apparatus according to one embodiment.

### DESCRIPTION OF THE EMBODIMENTS

Hereinafter, some embodiments will be described in detail with reference to the attached drawings. Note, the following embodiments are not intended to limit the scope of the claimed invention. Multiple features are described in the embodiments, but limitation is not made to embodiments that require all such features, and multiple such features may be combined as appropriate. Furthermore, in the attached drawings, the same reference numerals are given to the same or similar configurations, and redundant description thereof is omitted.

### First Embodiment

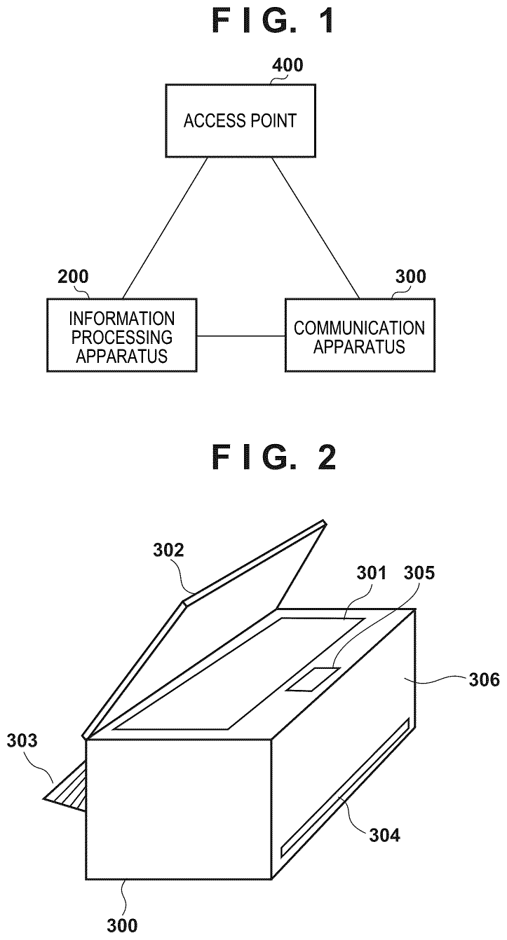

FIG. 1 is a diagram illustrating an example of a configuration of a system in the present embodiment. The present system is a wireless communication system in which a plurality of apparatuses can wirelessly communicate with each other. In FIG. 1, an information processing apparatus 200, a communication apparatus 300, and an access point 400 are included as the apparatuses. The information processing apparatus 200 is an apparatus that includes a function for wireless communication by a wireless LAN or the like. In the following, a wireless LAN may be referred to as a WLAN. The information processing apparatus 200 is, for example, a personal information terminal (e.g., personal digital assistant (PDA)), a portable telephone, a digital camera, or the like. The communication apparatus 300 is a printing apparatus that includes a print function and may further include a read function (scanner), a FAX function, and a telephone function. The communication apparatus 300 includes a function for wireless communication by a wireless LAN or the like and is capable of wirelessly communicating with the information processing apparatus 200. In the present embodiment, description will be given for a case where an MFP is used as an example of the communication apparatus 300, but the present invention is not limited thereto. For example, a scanner apparatus, a projector, a portable terminal, a smart phone, a notebook PC, a tablet terminal, a PDA, a digital camera, a music reproduction device, a TV, a smart speaker, or the like that includes a communication function may be used. MFP is an acronym of multi function peripheral.

The access point 400 is an external access point provided outside the information processing apparatus 200 and the communication apparatus 300 and operates as a WLAN base station apparatus. The access point 400 may also be referred to as a wireless base station. An apparatus that includes a WLAN communication function can communicate in WLAN infrastructure mode via the access point 400. In the following, an access point may be referred to as an “AP”. The infrastructure mode may be referred to as “wireless infrastructure mode”. The access point 400 wirelessly communicates with an (authenticated) apparatus that it permitted to be connected to it and relays wireless communication between that apparatus and another apparatus. The access point 400 may be connected to a wired communication network, for example, and relay communication between an apparatus connected to that wired communication network and another apparatus wirelessly connected to the access point 400.

The information processing apparatus 200 and the communication apparatus 300 may wirelessly communicate in the wireless infrastructure mode, which goes through the external access point 400, using their respectively included WLAN communication functions, or in peer-to-peer mode, which does not go through the external access point 400. In the following, peer-to-peer is also referred to as “P2P” or “P2P (WLAN)”. The P2P mode includes Wi-Fi Direct®, soft AP mode, and the like. In the following, Wi-Fi Direct® may be referred to as WFD. That is, it can be said that P2P (WLAN) is communication that complies with an IEEE 802.11 series. In the present embodiment, assume that the information processing apparatus 200 and the communication apparatus 300 are capable of executing processes that correspond to a plurality of printing services, using the WLAN communication, as will be described later.

FIG. 2 is a diagram illustrating an example of an external configuration of the communication apparatus 300. The communication apparatus 300 includes, for example, a document table 301, a document cover 302, a print sheet insertion port 303, a print sheet discharge port 304, and an operation display unit 305. The document table 301 is a table on which a document to be read is placed. The document cover 302 is a cover for pressing down a document placed on the document table 301 and preventing light from a light source that illuminates the document from leaking out at the time of reading. The print sheet insertion port 303 is an insertion slot in which sheets in supported sizes can be set. The print sheet discharge port 304 is a discharge port for discharging sheets on which printing has been completed. The sheets set in the print sheet insertion port 303 are conveyed to a print unit one by one and, after printing has been performed in the print unit, are discharged from the print sheet discharge port 304. The operation display unit 305 includes keys (e.g., character input keys, cursor keys, an enter key, and a cancel key), an LED or an LCD, and the like and is configured to be capable of accepting operation of various settings and activation of various functions as the MFP by a user. The operation display unit 305 may be configured to include a touch panel display. The communication apparatus 300 includes a function for wireless communication by a WLAN and is configured to include a wireless communication antenna 306 for that wireless communication although it need not always be visible on the outside. Similarly to the information processing apparatus 200, the communication apparatus 300 can wirelessly communicate in 2.4-GHz and 5-GHz frequency bands by a WLAN.

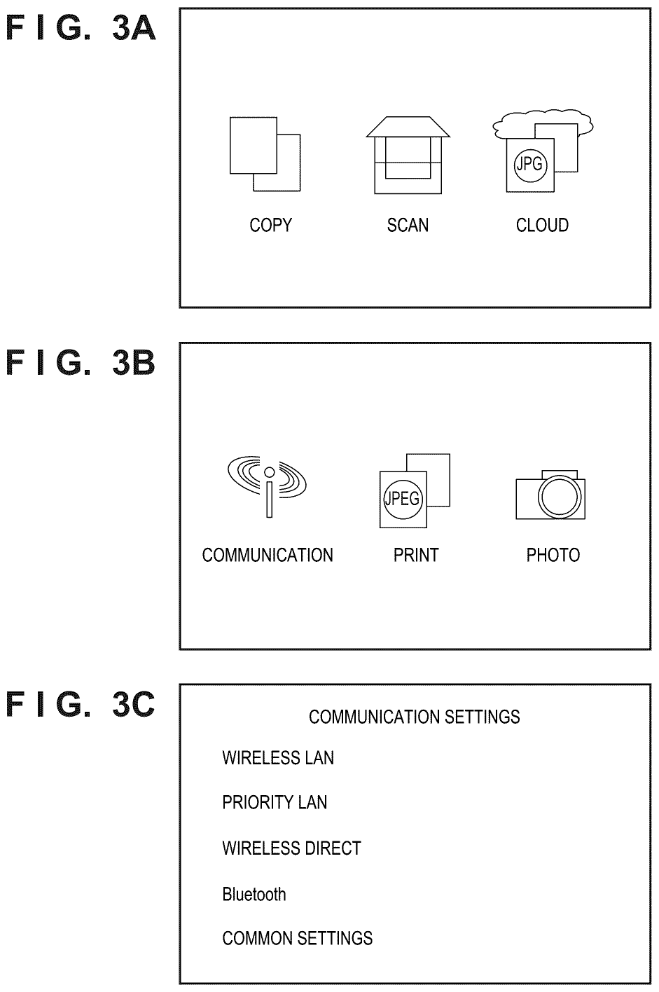

FIGS. 3A to 3C are diagrams illustrating an example of screen displays of the operation display unit 305 of the communication apparatus 300. FIG. 3A is an example of a home screen to be displayed during a state (idle state or standby state) in which the power of the communication apparatus 300 is turned on and operation, such as printing or scanning, has not been performed. By a menu display for a copy function, a scan function, or a cloud function that uses Internet communication, or the like, being selected by the user's key operation or touch panel operation, the communication apparatus 300 executes a corresponding setting or function. By accepting a key operation or a touch panel operation on the home screen of FIG. 3A, the communication apparatus 300 can seamlessly display a screen different from that of FIG. 3A. FIG. 3B is an example thereof and illustrates an example in which menu items for execution of a print or photo function and change of communication settings or the like are displayed. A print or photo function is executed or communication settings are executed, based on user selection in this screen.

FIG. 3C is an example of a communication interface selection screen to be displayed when communication settings are selected in the screen of FIG. 3B. In this screen, various LAN setting menu items for wired connection settings, a wireless infrastructure mode enabling/disabling setting, a P2P mode (e.g., WFD and soft AP mode) enabling/disabling setting, and the like are displayed so as be selectable. For example, in FIG. 3C, when “wireless LAN” is enabled by user operation, the wireless infrastructure mode is set to enabled, and when “wireless direct” is set to enabled by user operation, the P2P (WLAN) mode is enabled. Further, in this screen, a “common settings” menu item related to each connection mode is displayed so as to be selectable by the user. Furthermore, the user can perform, for example, settings for wireless LAN frequency bands and frequency channels from this screen.

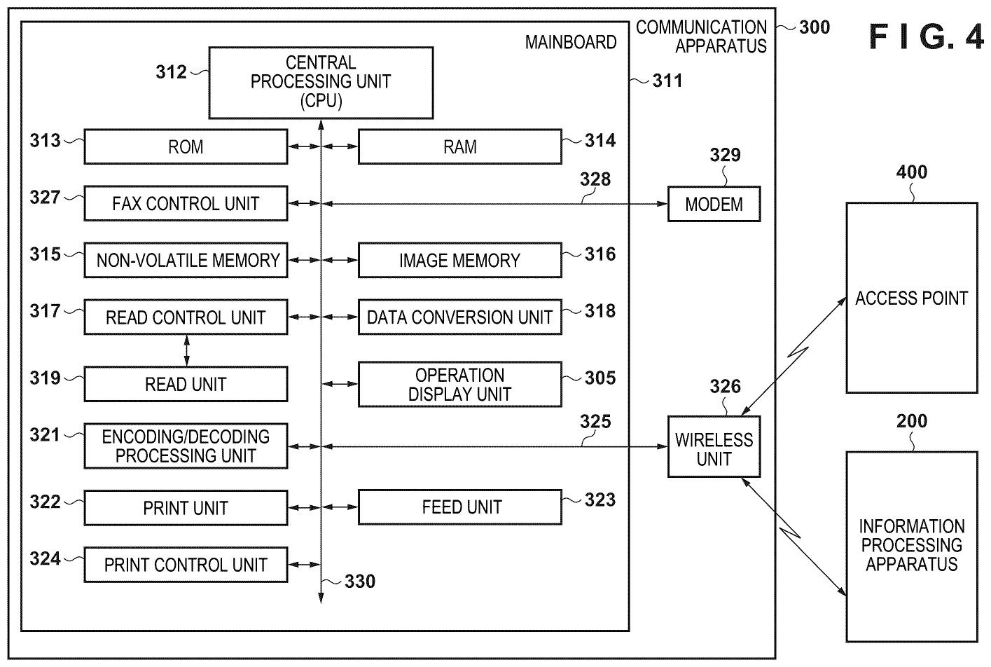

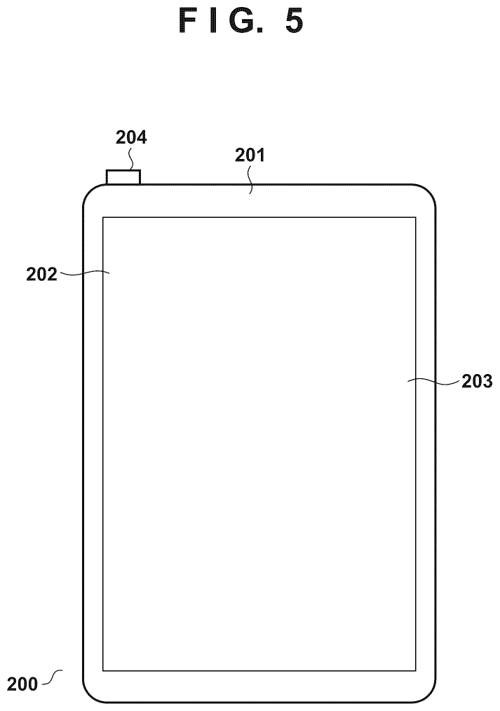

FIG. 4 is a diagram illustrating an example of a configuration of the communication apparatus 300. The communication apparatus 300 is configured to include a mainboard 311, which performs main control of the apparatus itself, and a wireless unit 326, which is a communication module that performs WLAN communication using at least one antenna. The communication apparatus 300 is configured to include, for example, a modem 329 for performing wired communication. The mainboard 311 is configured to include, for example, a CPU 312, a ROM 313, a RAM 314, a non-volatile memory 315, an image memory 316, a read control unit 317, a data conversion unit 318, a read unit 319, an encoding/decoding processing unit 321, and a FAX control unit 327. Further, the mainboard 311 is configured to include, for example, a print unit 322, a feed unit 323, a print control unit 324, and the operation display unit 305. These functional units in the mainboard 311 are connected to each other via a system bus 330, which is managed by the CPU 312. Further, the mainboard 311 and the wireless unit 326 are connected via a dedicated bus 325, for example, and the mainboard 311 and the modem 329 are connected via a bus 328 for example.

The CPU 312 is a system control unit and controls the entire communication apparatus 300. The processes of the communication apparatus 300, which will be described below, are realized in one example by the CPU 312 executing programs stored in the ROM 313. A dedicated piece of hardware may be prepared for each process. The ROM 313 stores control programs, an embedded OS program, and the like to be executed by the CPU 312. In the present embodiment, software control, such as scheduling and task switching, is performed by the CPU 312 executing the respective control programs stored in the ROM 313 under the control of the embedded OS stored in the ROM 313. The RAM 314 is constituted by an SRAM or the like. The RAM 314 stores data, such as program control variables, and data, such as setting values registered by the user and management data of the communication apparatus 300. Further, the RAM 314 may be used as a buffer for various kinds of work. The non-volatile memory 315 is configured by a memory, such as a flash memory, for example, and continues to store data even when the power of the communication apparatus 300 is turned off. The image memory 316 is constituted by a memory, such as a DRAM. The image memory 316 stores image data received via the wireless unit 326, image data processed by the encoding/decoding processing unit 321, and the like. The memory configuration of the communication apparatus 300 is not limited to the above-described configuration. For example, the image memory 316 and the RAM 314 may be shared. The data conversion unit 318 performs, for example, analysis of various forms of data and conversion of image data to print data.

The read control unit 317 optically reads a document placed on the document table 301 by controlling the read unit 319 (e.g., contact image sensor (CIS)). The read control unit 317 converts an image obtained by optically reading the document into electrical image data (image signal) and outputs it. At this time, the read control unit 317 may output the image data after having performed various kinds of image processing, such as binary processing and halftone processing. The operation display unit 305 executes display control, control for generating an electric signal corresponding to user operation, and the like. The operation display unit 305 displays the screens of FIGS. 3A to 3C, for example. The operation display unit 305 can display code information, such as a two-dimensional code.

The encoding/decoding processing unit 321 performs encoding processing and decoding processing as well as enlargement/reduction processing of image data (e.g., JPEG and PNG) handled by the communication apparatus 300. The feed unit 323 holds sheets for printing. The feed unit 323 can supply set sheets under the control of the print control unit 324. The feed unit 323 may include a plurality of feed units to hold a plurality of types of sheets in a single apparatus and can control from which feed unit to perform feeding under the control of the print control unit 324. The print control unit 324 performs various kinds of image processing, such as smoothing processing, print density correction processing, and color correction, on image data to be printed and outputs the processed image data to the print unit 322. The print unit 322 is configured to be capable of executing inkjet print processing, for example, and prints an image on a print medium, such as a sheet, by discharging, from a printhead, ink supplied from an ink tank. The print unit 322 may be configured to be capable of executing print processing of another print method, such as an electrophotographic method. Further, the print control unit 324 may periodically read information of the print unit 322 and update, for example, status information, which includes the remaining amount of the ink tank, the status of the printhead, and the like, stored in the RAM 314.

The wireless unit 326 is a unit capable of providing a WLAN communication function and is capable of providing functions similar to those of a WLAN unit 201 of the information processing apparatus 200, for example. That is, the wireless unit 326 converts data into packets and transmits the packets to another device and restores original data from packets from another, external device and outputs it to the CPU 312 according to a WLAN standard. The wireless unit 326 is capable of communicating as a station that complies with the IEEE 802.11 standard series. In the following, a station may be referred to as an STA. The information processing apparatus 200 and the communication apparatus 300 are capable of P2P (WLAN) communication based on WFD, and the wireless unit 326 includes a software access point (soft AP) function or a group owner function. That is, the wireless unit 326 can construct a P2P communication network and determine channels to be used in P2P communication.

Here, modes and connection methods of executing wireless communication using the wireless unit 326 will be described.

### <Regarding Direct Connection Method>

Direct connection refers to a form in which apparatuses are directly connected to each other without going through an external device, such as the AP 400. Direct connection is also referred to as Peer to Peer connection (P2P connection). The communication apparatus 300 is capable of operating in a mode (direct connection mode) for performing communication by direct connection as one of the connection modes. In Wi-Fi communication, there are a plurality of modes for performing communication by direct connection, such as software AP mode and Wi-Fi Direct (WFD) mode.

A mode in which direct connection is executed by WFD is called the WFD mode. WFD is a standard established by Wi-Fi Alliance and is a standard included in the IEEE 802.11 series communication standard. In the WFD mode, after a search for a device to be a communication partner has been performed according to a device search command, P2P group owner (GO) and P2P client roles are determined, and then remaining wireless connection processing is performed. A group owner corresponds to a Wi-Fi master station (master device), and a client corresponds to a Wi-Fi slave station (slave device). This role determination is also called GO Negotiation. In the WFD mode in a state prior to role determination, the communication apparatus 300 is in a state in which it is neither a master station nor a slave station. Specifically, between devices that perform communication, first, one device issues a device search command and searches for a device with which to connect in the WFD mode. When the other device to be a communication partner is found, information related to services and functions that each device can provide is confirmed between the two. This confirmation of device provision information is optional and not mandatory. This device provision information confirmation phase corresponds to, for example, P2P Provision Discovery. Next, by confirming each other's device provision information, it is determined which will be a P2P client and which will a P2P group owner as their roles. Next, when the client and the group owner are determined, they exchange parameters for communicating with each other via WFD. Remaining wireless connection processing and IP connection processing are performed between the P2P client and group owner based on the exchanged parameters. In the WFD mode, the communication apparatus 300 may always operate as a GO without executing the above-described GO Negotiation in the communication apparatus 300. That is, the communication apparatus 300 may operate in WFD mode that is Autonomous GO mode. That is, a state in which the communication apparatus 300 is operating in the WFD mode is, for example, a state in which connection via WFD is not established but the communication apparatus 300 is operating as a GO or a state in which connection via WFD is established and the communication apparatus 300 is operating as a GO.

In the software AP mode (soft AP mode), between devices (e.g., information processing apparatus 200 and communication apparatus 300) that perform communication, one device (e.g., information processing apparatus 200) is a client that fulfills a role of requesting various services. The other device realizes a function of an access point in Wi-Fi according to software settings. The software AP corresponds to a Wi-Fi master station, and a client corresponds to a Wi-Fi slave station. In the software AP mode, a client searches for a device to be the software AP according to a device search command. When the software AP is found, remaining wireless connection processing (e.g., establishment of wireless connection) is performed between the client and the software AP, and then IP connection processing (e.g., assigning of an IP address) is performed. Regarding commands and parameters to be transmitted and received when realizing wireless connection between the client and the software AP, those specified in a Wi-Fi standard may be used, and the description thereof will be omitted here.

In the present embodiment, when the communication apparatus 300 establishes and maintains direct connection, the communication apparatus 300 operates as a master station in a network to which it belongs. A master station is a device that constructs a wireless network and is a device that provides parameters used to connect to the wireless network to a slave station. The parameters used to connect to the wireless network are, for example, parameters related to the channel used by the master station. By receiving the parameters, a slave station connects to the wireless network constructed by the master station using the channels used by the master station. In the direct connection mode, the communication apparatus 300 operates as a master station, and so, the communication apparatus 300 can determine which frequency bands and channels to use for communication in the direct connection mode. In the present embodiment, assume that the communication apparatus 300 can use channels corresponding to a 2.4-GHz frequency band and channels corresponding to a 5-GHz frequency band for communication in the direct connection mode.

### <Regarding Infrastructure Connection Method>

Infrastructure connection is a connection form for devices (e.g., information processing apparatus 200 and communication apparatus 300) that perform communication to connect with an access point (e.g., AP 400) that controls a network of the devices and communicate with each other via the access point. The communication apparatus 300 is capable of operating in a mode (infrastructure connection mode) for performing communication by infrastructure connection as one of the connection modes.

In infrastructure connection, each device searches for an access point according to a device search command. When an access point is found, remaining wireless connection processing (e.g., establishment of wireless connection) is performed between the device and the access point, and then IP connection processing (e.g., assigning of an IP address) is performed. Regarding commands and parameters to be transmitted and received when realizing wireless connection between the device and the access point, those specified in a Wi-Fi standard may be used, and the description thereof will be omitted here.

In the present embodiment, when the communication apparatus 300 operates in infrastructure connection, the AP 400 operates as a master station and the communication apparatus 300 operates as a slave station. That is, in the present embodiment, infrastructure connection refers to connection between the communication apparatus 300 operating as the slave device and an apparatus operating as the master device. When the communication apparatus 300 establishes an infrastructure connection and the information processing apparatus 200 establishes an infrastructure connection with the AP 400, communication via the AP 400 becomes possible between the communication apparatus 300 and the information processing apparatus 200. The channels used for communication in infrastructure connection are determined by the AP 400, and so, the communication apparatus 300 performs communication in infrastructure connection using the channels determined by the AP 400. In the present embodiment, assume that the communication apparatus 300 can use channels corresponding to a 2.4-GHz frequency band and channels corresponding to a 5-GHz frequency band for communication in infrastructure connection. The communication apparatus 300 can also use channels corresponding to a Dynamic Frequency Selection (DFS) band of the 5-GHz frequency band for communication in infrastructure connection. In order to communicate with the communication apparatus 300 via the AP 400, the information processing apparatus 200 needs to recognize that the communication apparatus 300 belongs to a network that has been formed by the AP 400 and to which the information processing apparatus 200 belongs.

### <Regarding Network Setup Mode>

The communication apparatus 300 can operate in network setup mode. A trigger for the communication apparatus 300 to start operation in the network setup mode may be, for example, that the user presses a button for the network setup mode or that the communication apparatus 300 activates (powers on) for the first time after arrival. The button for the network setup mode may be a hardware (physical) button provided in the communication apparatus 300 or a software button displayed by the communication apparatus 300 on the operation display unit 305.

The communication apparatus 300 enables Wi-Fi communication when it starts operating in the network setup mode. Specifically, the communication apparatus 300 enables an AP (connection setting AP) inside the communication apparatus 300 dedicated to the network setup mode as Wi-Fi communication enabling processing. With this, the communication apparatus 300 enters a state in which it is possible to establish a direct connection with the information processing apparatus 200 via Wi-Fi. Assume that connection information for connecting with the connection setting AP is held in advance in a setup application installed on the information processing apparatus 200 and the information processing apparatus 200 knows in advance the connection information for connecting with the connection setting AP. The connection information is, for example, a service set identifier (SSID) and a password. Assume that, therefore, unlike connection information of an AP that is enabled in the direct connection mode, the connection information for connecting to the connection setting AP cannot be changed as desired by the user. In the network setup mode, the communication apparatus 300 may connect with the information processing apparatus 200 via Wi-Fi Direct (WFD) instead of traditional Wi-Fi. That is, the communication apparatus 300 may operate as a group owner and receive a setting command from the information processing apparatus 200 via WFD communication. Further, in the network setup mode, the communication apparatus 300 may be connected to the information processing apparatus 200 via Bluetooth. Here, Bluetooth includes Bluetooth Classic and Bluetooth Low Energy (BLE). That is, for example, the communication apparatus 300 may operate as a slave device in BLE in the network setup mode and receive a setting command from the information processing apparatus 200 via communication over BLE. Further, in the network setup mode, the communication apparatus 300 may be capable of executing both network setup via Wi-Fi and network setup via BLE. That is, the communication apparatus 300 may enable both Wi-Fi communication and BLE communication when it starts operating in the network setup mode. Specifically, the communication apparatus 300 may perform both enabling of the connection setting AP and enabling of an advertising state, in which advertisement information is transmitted via BLE so as to allow BLE connection, when it starts operating in the network setup mode.

When operating in the network setup mode, the communication apparatus 300 controls the wireless unit 326 and operates as a setup access point (connection setting AP), which is enabled only during operation in the network setup mode. The setup access point is an access point that is different from an access point that is enabled during the above-described soft AP mode. Further, assume that the SSID of the setup access point includes a predetermined character string that can be recognized by a setting application of the information processing apparatus 200.

Further, assume that the communication apparatus 300 operating in the network setup mode uses a predetermined communication protocol (setup communication protocol) in communication with the information processing apparatus 200 connected with the setup access point. The setup communication protocol is, more specifically, Simple Network Management Protocol (SNMP), for example.

The communication apparatus 300 stops operation in the network setup mode when a predetermined period of time elapses from the start of operation in the network setup mode and disables the setup access point. It also disables the setup access point when the connection information for connecting to the AP 400 and an instruction to change the wireless communication operation mode is received from the information processing apparatus 200 during the network setup mode. Further, assume that the setup access point is an access point that does not require a password for connection. The setup access point may be an access point that requires a password. In that case, assume that a password to be used for connection with the setup access point is a fixed password (that cannot be changed by the user) known in advance by the setting application.

FIG. 5 is a diagram illustrating an example of an external configuration of the information processing apparatus 200. In the present embodiment, a case where the information processing apparatus 200 is a typical form of smartphone will be described as one example. The information processing apparatus 200 is configured to include, for example, a display unit 202, an operation unit 203, and a power key 204. The display unit 202 is, for example, a display that includes a liquid crystal display (LCD) display mechanism. The display unit 202 may display information using, for example, a light emitting diode (LED) or the like. The information processing apparatus 200 may include a function for outputting information by audio in addition to or in place of the display unit 202. The operation unit 203 is configured to include hardware keys (e.g., keys or buttons), a touch panel, and the like for detecting user operation. In this example, information display on the display unit 202 and reception of user operation through the operation unit 203 are performed using a common touch panel display, and so, the display unit 202 and the operation unit 203 are realized by one apparatus. In this case, for example, a button icon and a software keyboard are displayed using a display function of the display unit 202, and a touch on those portions by the user is detected by an operation accepting function of the operation unit 203. The display unit 202 and the operation unit 203 may be separated, and hardware for display and hardware for operation acceptance may be individually prepared. The power key 204 is a physical key for accepting user operation for turning the power of the information processing apparatus 200 on or off.

The information processing apparatus 200 includes the WLAN unit 201, which provides a WLAN communication function, although it need not always be visible on the outside. The WLAN unit 201 is configured to be capable of executing data (packet) communication in a WLAN system that complies with the IEEE 802.11 standard series (e.g., IEEE 802.11a/b/g/n/ac/ax), for example. However, the WLAN unit 201 is not limited thereto and may be capable of executing communication of a WLAN system that complies with another standard. In this example, assume that the WLAN unit 201 is capable of communicating in both the 2.4-GHz and 5-GHz frequency bands. Further, assume that the WLAN unit 201 is capable of performing communication based on WFD, communication according to the soft AP mode, communication according to the wireless infrastructure mode, and the like.

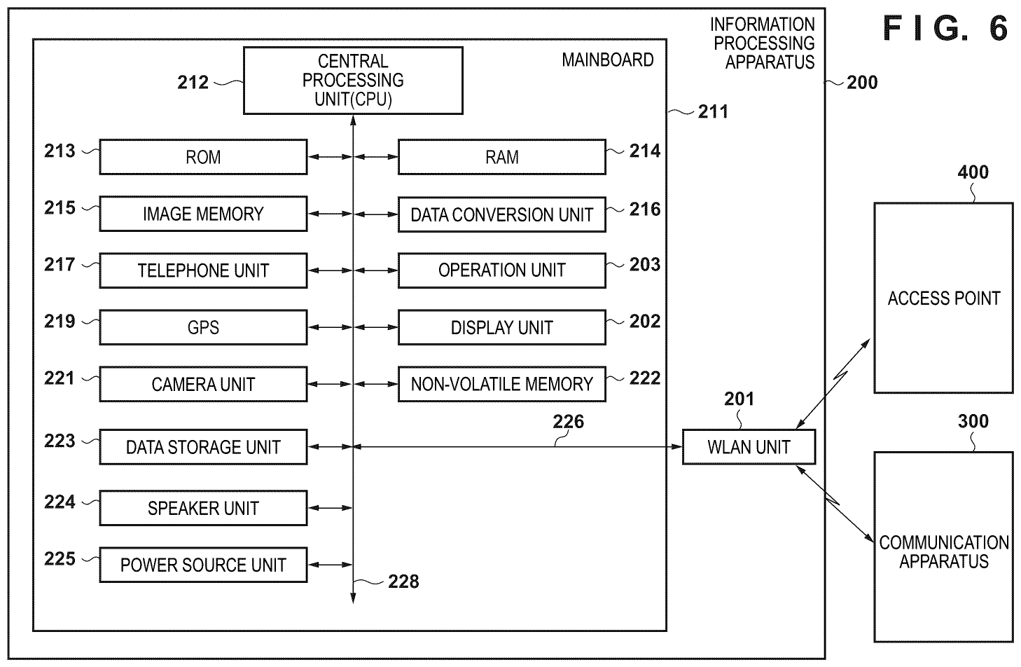

FIG. 6 is a diagram illustrating an example of a configuration of the information processing apparatus 200. In one example, the information processing apparatus 200 includes a mainboard 211, which performs main control of the apparatus itself, and the WLAN unit 201, which performs WLAN communication. The mainboard 211 includes, for example, a CPU 212, a ROM 213, a RAM 214, an image memory 215, a data conversion unit 216, a telephone unit 217, a GPS 219, a camera unit 221, a non-volatile memory 222, a data storage unit 223, a speaker unit 224, and a power supply unit 225. Here, CPU is an acronym for central processing unit, ROM is an acronym for read only memory, RAM is an acronym for random access memory, and GPS is an acronym for Global Positioning System. The information processing apparatus 200 includes the display unit 202 and the operation unit 203. These functional units in the mainboard 211 are connected to each other via a system bus 228, which is managed by the CPU 212. Further, the mainboard 211 and the WLAN unit 201 are connected via a dedicated bus 226, for example.

The CPU 212 is a system control unit and controls the entire information processing apparatus 200. The processes of the information processing apparatus 200, which will be described below, are realized in one example by the CPU 212 executing programs stored in the ROM 213. A dedicated piece of hardware may be prepared for each process. The ROM 213 stores control programs, an embedded operating system (OS) program, and the like to be executed by the CPU 212. In the present embodiment, software control, such as scheduling and task switching, is performed by the CPU 212 executing the respective control programs stored in the ROM 213 under the control of the embedded OS stored in the ROM 213. The RAM 214 is constituted by a static RAM (SRAM) or the like. The RAM 214 stores data, such as program control variables, and data, such as setting values registered by the user and management data of the information processing apparatus 200. Further, the RAM 214 may be used as a buffer for various kinds of work. The image memory 215 is constituted by a memory, such as a dynamic RAM (DRAM). The image memory 215 temporarily stores image data received via the WLAN unit 201 and image data read from the data storage unit 223 in order to processes them in the CPU 212. The non-volatile memory 222 is configured by a memory, such as a flash memory, for example, and continues to store data even when the power of the information processing apparatus 200 is turned off. The memory configuration of the information processing apparatus 200 is not limited to the above-described configuration. For example, the image memory 215 and the RAM 214 may be shared, or data may be backed up or the like using the data storage unit 223. Further, although a DRAM has been given as an example of the image memory 215 in the present embodiment, another storage medium, such as a hard disk or a non-volatile memory, may be used.

The ROM 213 stores a service registration application, an application program for executing network setup of the communication apparatus 300, a printer management application, a print information generation program for generating print information that can be interpreted by the communication apparatus 300, and the like. Each program is stored in the ROM 213 for example, by being installed from an external server (not illustrated) by Internet communication via the WLAN unit 201. The service registration application is an application program for transmitting information obtained from the communication apparatus 300, personal information of the user obtained by the information processing apparatus 200, and the like to a service management server (not illustrated). The application program (setting application) for executing network setup of the communication apparatus 300 is an application program for performing settings for an access point that is a connection destination of the communication apparatus 300. The printer management application is an application for managing information of a printer. The service registration application, the setting application, the printer management application, and the print information generation program (print application) may be configured as a single application.

The data conversion unit 216 analyzes various forms of data and performs data conversion, such as color conversion and image conversion. The telephone unit 217 controls a telephone line and, by processing audio data inputted and outputted via the speaker unit 224, realizes communication by telephone. The GPS 219 receives radio waves transmitted from a satellite and obtains position information, such as the current latitude and longitude of the information processing apparatus 200. The camera unit 221 includes a function for electronically recording and encoding an image inputted through a lens. Image data obtained by the camera unit 221 capturing an image is stored in the data storage unit 223. The speaker unit 224 performs control for realizing a function for inputting or outputting audio for the telephone function and other functions, such as alarm notification. The power supply unit 225 is, for example, a portable battery and performs control for supplying power to the apparatus. Power states include, for example, a battery exhausted state in which there is no remaining power in the battery, a power-off state in which the power key 204 has not been pressed, an activated state in which the apparatus is normally activated, and a power saving state in which the apparatus is activated but saving power. The display unit 202 is the display unit 202 described with reference to FIG. 5 and electronically controls display content and executes control for various input operations and for displaying, for example, a status state and an operation state of the MFP 300. The operation unit 203 is the operation unit 203 described with reference to FIG. 5, and upon accepting a user operation, executes control, such as generating an electrical signal that corresponds to that operation and outputting the signal to the CPU 212.

The information processing apparatus 200 performs wireless communication using the WLAN unit 201 and performs data communication with another device, such as the communication apparatus 300. The WLAN unit 201 converts data into packets and transmits the packets to another device. The WLAN unit 201 restores original data from packets from another, external device and outputs it to the CPU 212. The WLAN unit 201 is a unit for realizing communication that complies with the respective WLAN standards. The WLAN unit 201 may operate in parallel in at least two communication modes, which includes the wireless infrastructure mode and the P2P (WLAN) mode. The frequency bands to be used in these communication modes may be limited according to the functions and performance of hardware.

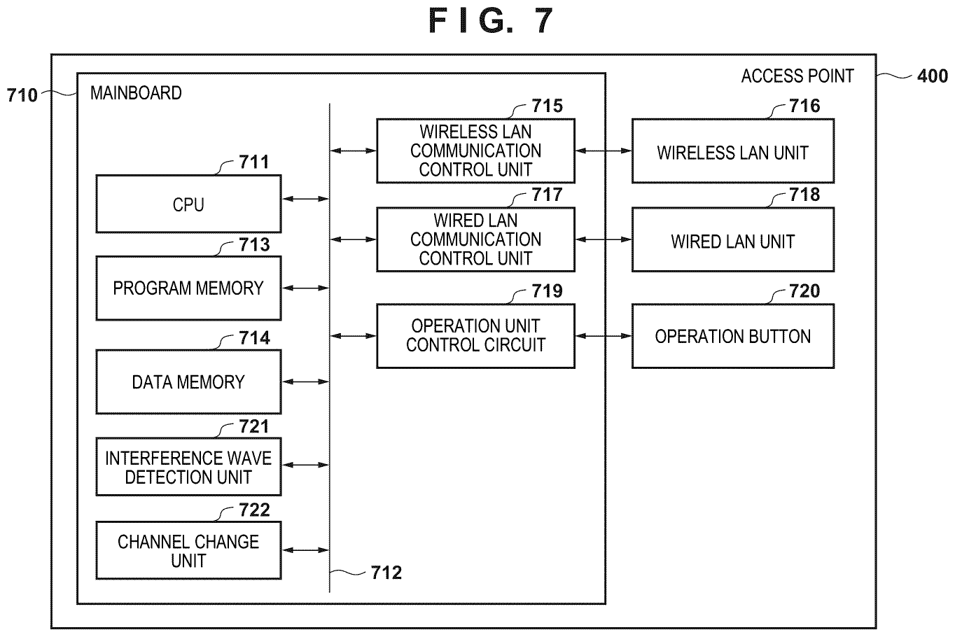

FIG. 7 is a block diagram illustrating an example of a configuration of the access point 400 that includes a wireless LAN access point function. The access point 400 is configured to include a mainboard 710 which controls the access point 400, a wireless LAN unit 716, a wired LAN unit 718, and an operation button 720.

A CPU 711, which is arranged on the mainboard 710, operates according to control programs stored in a ROM-form program memory 713, which is connected via an internal bus 712, and data stored in a RAM-form data memory 714. The CPU 711 performs wireless LAN communication with another apparatus by controlling the wireless LAN unit 716 through a wireless LAN communication control unit 715. The CPU 711 performs wired LAN communication with another apparatus by controlling the wired LAN unit 718 through a wired LAN communication control unit 717. The CPU 711 can accept an operation from the user through the operation button 720 by controlling an operation unit control circuit 719.

The access point 400 is configured to include an interference wave detection unit 721 and a channel change unit 722. The interference wave detection unit 721 performs interference wave detection processing when wireless communication is being executed in a band in which DFS is performed. The channel change unit 722 performs processing for changing a channel to be used in cases such as where an interference wave is detected when wireless communication is being performed in a band in which DFS is performed and a case where it is necessary to immediately change to a vacant channel.

In the present embodiment, the information processing apparatus 200 can execute a function called Wi-Fi Easy Connect (hereinafter, WEC)® when it supports that function. WEC is a function for executing network setup of the communication apparatus 300 using Device Provisioning Protocol (hereinafter, DPP) established by Wi-Fi Alliance. Specifically, the network setup of the communication apparatus 300 is processing for connecting another apparatus to an access point forming a network. In WEC, communication is performed between an apparatus (hereinafter, referred to as Configurator apparatus) that operates in a role of “Configurator” and an apparatus (hereinafter, referred to as Enrollee apparatus) that operates in a role of “Enrollee”. In the present embodiment, assume that the Configurator apparatus is an Initiator in DPP and the Enrollee apparatus is a Responder in DPP.

The Enrollee apparatus activates DPP Listen mode (hereinafter referred to as DPP waiting mode) in which communication is awaited in a wireless connection channel included in WEC-related information. The Configurator apparatus establishes a DPP connection with the Enrollee apparatus, which is in the DPP waiting mode, using the obtained WEC-related information.

In Bootstrapping, the Configurator apparatus obtains Bootstrapping information from the Enrollee apparatus. In the present embodiment, Bootstrapping information is obtained, for example, by reading a QR code that is displayed so as to be obtainable by the communication apparatus 300 capturing an image and by analyzing the read QR code. The Bootstrapping information includes, for example, identification information (e.g., MAC address) of the Enrollee apparatus, public key information used for performing secure communication with the Enrollee apparatus, and the like. In the present embodiment, the Bootstrapping information will be described as “WEC-related information”. Other information may also be treated as the WEC-related information. The Configurator apparatus can establish a DPP connection with the Enrollee apparatus, which is in the DPP waiting mode, using the obtained WEC-related information.

The Configurator apparatus executes wireless communication with the Enrollee apparatus, using the obtained Bootstrapping information. Specifically, for example, the Configurator apparatus multiplies a bootstrapping public key Br included in the Bootstrapping information by a temporarily generated ephemeral private key pi and generates a shared secret k1. It also transmits a DPP Authentication Request that contains an ephemeral public key Pi, which forms a pair with the above-described ephemeral private key pi, to the Enrollee apparatus. Upon receiving that request, the Enrollee apparatus multiplies a bootstrapping private key br, which forms a pair with the bootstrapping public key Br, and the received ephemeral public key Pi and derives the shared secret k1. With this processing, the Configurator apparatus and the Enrollee apparatus share the shared secret k1. This processing corresponds to the sharing of cryptographic keys based on an Elliptic Curve Diffie-Hellman (ECDH) key sharing method.

Further, the Enrollee apparatus multiplies the received ephemeral public key Pi and an ephemeral secret key pr that it holds and derives a shared secret k2. It also returns a DPP Authentication Response that contains an ephemeral public key Pr, which forms a pair with the ephemeral secret key pr, to the Configurator apparatus. The Configurator apparatus generates the shared secret k2, using the received ephemeral public key Pr and the ephemeral private key pi that it holds. This processing corresponds to key sharing that is based on an Elliptic Curve Diffie-Hellman Ephemeral (ECDHE) key sharing method of sharing cryptographic keys, in which each uses a temporarily generated public/secret key.

Finally, the Configurator apparatus and the Enrollee apparatus, which share k1 and k2, input k1 and k2 as input parameters in a key deriving function and derive a common key ke, which is used for DPP communication.

Thereafter, DPP Configuration processing is executed using the common key ke shared between the two parties. Specifically, the Enrollee apparatus transmits a DPP Configuration Request to the Configurator apparatus. The contents of that request are encrypted with the common key ke. Upon receiving that request, the Configurator apparatus transmits a DPP Configuration Response that contains information of an access point selected by the user to the Enrollee apparatus. The information of the access point is a service set identifier (SSID) of the access point and a password of the access point. Upon receiving the response, the Enrollee apparatus decodes the contents of the response with ke and obtains the information of the access point. Finally, the Enrollee apparatus establishes wireless connection with the access point based on the information of the access point obtained by decoding. The Enrollee apparatus activates a Station (STA) and establishes wireless infrastructure connection with the access point, using access point connection information received from the Configurator apparatus.

Description will be given assuming that the information processing apparatus 200, which supports WEC, operates as the Configurator apparatus in the network setup processing according to WEC in the present embodiment. Further, description will be given assuming that the communication apparatus 300, which supports WEC, operates as the Enrollee apparatus. Further, description will be given assuming that it operates as the STA in connection between the Enrollee apparatuses.

Hereinafter, wireless network setup in which the information processing apparatus 200 and the communication apparatus 300 are connected and WEC is used to cause the communication apparatus 300 to participate in a wireless infrastructure network established by the access point 400 in which the information processing apparatus 200 is participating will be described. Further, in the present embodiment, the WEC-related information is discarded at a predetermined timing.

As described above, in DPP, the Enrollee provides the Bootstrapping information containing a public key to the Configurator, and a key pair of that public key and a private key realize secure authentication. Specifically, authentication that is based on a key pair is performed in DPP Authentication, and security is ensured by encryption using a shared key. A key pair is generally hard to infer but may be inferred due to algorithm vulnerabilities or by brute force attacks. Further, when the Bootstrapping information is provided in a QR code, for example, if an apparatus that operates as the Enrollee only includes a small display unit, it is conceivable that the key length will be shorter and the strength of the key will decrease.

In the present embodiment, the WEC-related information is discarded at a predetermined timing, and so, it is possible to update the key pair at relatively small intervals and further improve security.

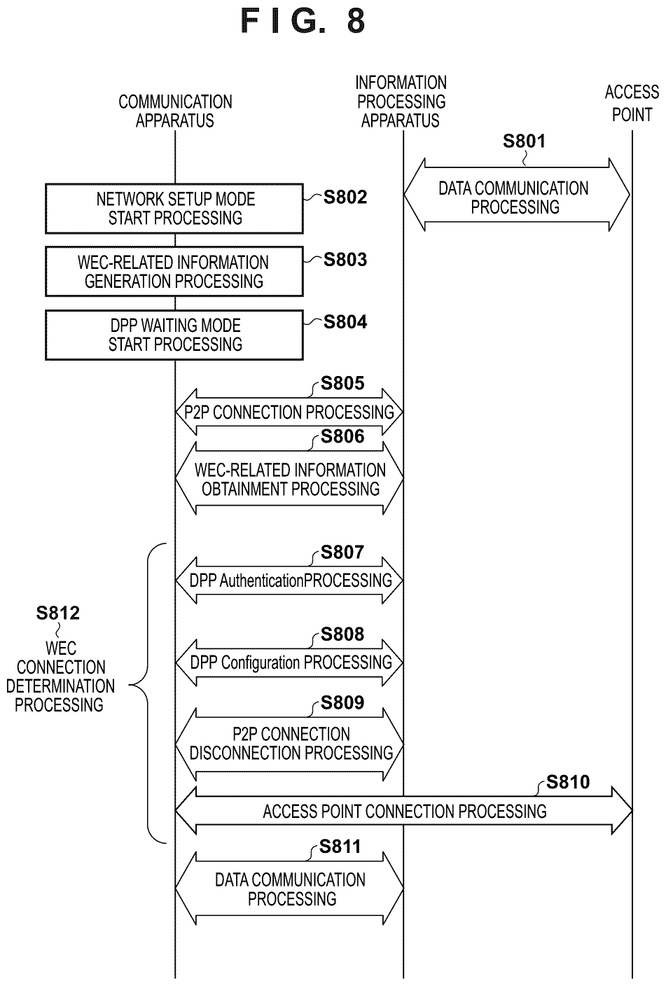

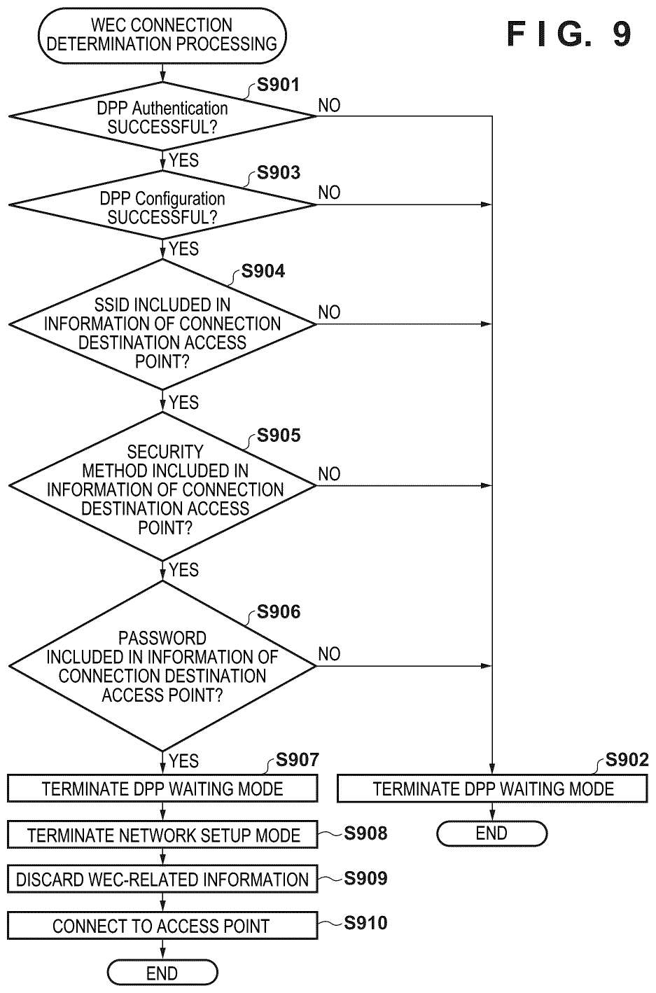

FIG. 8 is a diagram illustrating an example of a sequence for performing network setup according to WEC. The processing of each apparatus of FIG. 8 is realized, for example, by the CPU of each apparatus reading a program stored in the ROM out to the RAM and executing it.

In the present embodiment, assume that, before the sequence of FIG. 8 is started, the information processing apparatus 200 already holds communication parameters for connecting and communicating with a wireless infrastructure network formed by the access point 400. That is, in step S801, the information processing apparatus 200 performs processing for performing data communication with another apparatus via the access point 400.

In step S802, the communication apparatus 300 starts the network setup mode. As described above, the network setup mode may be started, for example, by the user pressing a button for the network setup mode or by the communication apparatus 300 being activated (powered on) for the first time after arrival. That is, it may be triggered, for example, by the start of a processing sequence for performing initial settings in a factory shipment state (arrival state). In step S802, the communication apparatus 300 determines a frequency band and a frequency channel, activates the wireless unit 326 as a setup access point, and causes it to operate as a parent station. That is, the CPU 312 causes the communication apparatus 300 to start operation in the network setup mode. This makes it possible for an external apparatus, such as a personal computer, a smartphone, or a tablet, to connect with the communication apparatus 300 as a client (slave unit) and perform communication therewith. At the time of network setup, the 2.4-GHz or 5-GHz frequency band is used. Which frequency band to use may be determined, for example, by the communication apparatus 300 based on surrounding wireless communication conditions. For example, the communication apparatus 300 may cause the wireless unit 326 to operate as an access point that uses the 5-GHz band if it determines that wireless communication that uses the 2.4-GHz band is more congested than wireless communication that uses the 5-GHz band.

In step S803, the communication apparatus 300 performs WEC-related information generation processing. The WEC-related information includes, for example, identification information (e.g., MAC address) of the communication apparatus 300, public key information used for performing secure communication between the communication apparatus 300 and the information processing apparatus 200, and the like. In the present embodiment, the communication apparatus 300 generates code information based on the WEC-related information and displays it on the operation display unit 305. The code information is, for example, a two-dimensional code, such as a QR Code®. Further, in the present embodiment, the internally-held WEC-related information is discarded as will be described later. Therefore, the WEC-related information generation processing of step S803 is executed every time network setup according to WEC is executed. That is, each time network setup according to WEC is executed, a portion of the WEC-related information, such as key information, may be updated.

In step S804, the communication apparatus 300 performs DPP waiting mode start processing. In the present embodiment, the CPU 312 of the communication apparatus 300 causes the communication apparatus 300 to start operation in the DPP waiting mode based on that the communication apparatus 300 has started operation in the network setup mode, for example. That is, in step S804, the CPU 312 determines a DPP communication waiting channel and causes the communication apparatus 300 to start operation in the DPP waiting mode. This makes it possible to communicate using DPP with an external apparatus, such as the information processing apparatus 200. Which channel to use as the DPP communication waiting channel may be set by the user from an operation screen of the communication apparatus 300, for example.

Next, in step S805, P2P connection processing is executed between the communication apparatus 300 and the information processing apparatus 200. In the P2P connection processing, for example, processing for the communication apparatus 300 to establish a P2P (WLAN) connection, which is defined by IEEE 802.11, with the information processing apparatus 200 is executed.

Then, in step S806, WEC-related information obtainment processing is executed between the communication apparatus 300 and the information processing apparatus 200. In the present embodiment, for example, WEC-related information obtainment processing is executed by the information processing apparatus 200 imaging a QR code displayed on the operation display unit 305 of the communication apparatus 300. The information processing apparatus 200 thus obtains the WEC-related information from the communication apparatus 300. The WEC-related information may be obtained via Bluetooth Low Energy (BLE) and near field communication (NFC).

Next, in step S807, processing called DPP Authentication is executed between the communication apparatus 300 and the information processing apparatus 200. The processing of step S807 is performed, for example, based on a user instruction on a WEC start screen according to a WEC application in the information processing apparatus 200. The WEC application is an application that is activated by instructing the OS from the setting application in the information processing apparatus 200. In DPP Authentication, authentication information, information used for encrypting information, and the like are communicated between the communication apparatus 300 and the information processing apparatus 200, and authentication of communication between the apparatuses is performed. Various kinds of information transmitted from the information processing apparatus 200 in communication in DPP Authentication are encrypted based on the WEC-related information obtained in step S806. The communication apparatus 300 authenticates communication with the information processing apparatus 200 when it succeeds in decrypting the information received from the information processing apparatus 200 using a decryption key held in advance. If the information processing apparatus 200 has not been able to obtain accurate WEC-related information and cannot accurately encrypt information, decryption at the communication apparatus 300 will fail, and so, the authentication will fail. In DPP Authentication, communication is performed using DPP.

Next, in step S808, processing called DPP Configuration is executed between the communication apparatus 300 and the information processing apparatus 200. In DPP Configuration, the information processing apparatus 200 transmits connection information for connecting with the access point 400, which is set as a target of setting according to WEC, to the communication apparatus 300 by DPP. The connection information includes, for example, information indicating an SSID, a password, and an encryption method of the access point 400, which is set as a target of setting according to WEC. In DPP Configuration, communication is performed using DPP.

Then, in step S809, P2P connection disconnection processing is executed between the communication apparatus 300 and the information processing apparatus 200. The P2P connection disconnection processing may be processing for disconnecting P2P (WLAN) connection, which is defined by IEEE 802.11.

Next, in step S810, the communication apparatus 300 executes processing for connecting with the access point 400, using the connection information for connecting with the access point 400 obtained in step S808. If a communication error occurs in DPP, if the access point 400 is not found, if the WEC-related information is not appropriate information, or the like, connection with the access point 400 in step S810 will fail. Further, for example, if an encryption method used for connection with the access point 400, which is set as a target of setting according to WEC, is an encryption method not supported by the communication apparatus 300, connection with the access point 400 in step S810 will also fail.

Upon successfully connecting with the access point 400 in step S810, the communication apparatus 300 can perform processing for data communication with the information processing apparatus 200 via the access point 400 in step S811.

FIG. 9 is a flowchart illustrating the processing of steps S807 to S810 (WEC connection determination processing (step S812)) of FIG. 8. The processing of FIG. 9 is realized, for example, by the CPU 312 reading a program stored in the ROM 313 out to the RAM 314 and executing it.

In step S901, the CPU 312 determines whether processing for DPP Authentication with the information processing apparatus 200 has been successful. As described above, various kinds of information transmitted from the information processing apparatus 200 in communication in DPP Authentication are encrypted based on the WEC-related information obtained in step S806. The CPU 312 authenticates communication with the information processing apparatus 200 when it succeeds in decrypting the information received from the information processing apparatus 200 using a decryption key held in advance. If the information processing apparatus 200 has not been able to obtain accurate WEC-related information and cannot accurately encrypt information, decryption at the communication apparatus 300 will fail, and so, the authentication will fail. Accordingly, if authentication of communication with the information processing apparatus 200 has been successful, the CPU 312 determines that DPP Authentication has been successful, and if authentication has been unsuccessful, it determines that DPP Authentication has been unsuccessful. If it is determined that DPP Authentication processing has been unsuccessful, in step S902 the CPU 312 terminates the DPP waiting mode and terminates the WEC connection determination processing of FIG. 9. Meanwhile, if it is determined that DPP Authentication processing has been successful, the processing proceeds to step S903.

In step S903, the CPU 312 determines whether processing for DPP Configuration with the information processing apparatus 200 has been successful. For example, the CPU 312 determines that the processing has been successful if it receives connection information for connecting with an access point, which is set as a target of setting according to WEC, from the information processing apparatus 200 by WEC, and that the processing has been unsuccessful if it has not received the connection information. If it is determined that DPP Configuration processing has been unsuccessful, in step S902 the CPU 312 terminates the DPP waiting mode and terminates the WEC connection determination processing of FIG. 9. Meanwhile, if it is determined that DPP Configuration processing has been successful, the processing proceeds to step S904.

If DPP Configuration processing has been successful, the CPU 312 obtains information of the access point 400, which is set as a target of setting according to WEC.

In step S904, the CPU 312 determines whether an SSID is included in the information of the connection destination access point received from the information processing apparatus 200. If it is determined that an SSID is not included in the information of the connection destination access point, in step S902 the CPU 312 terminates the DPP waiting mode and terminates the WEC connection determination processing of FIG. 9. Meanwhile, if it is determined that an SSID is included in the information of the connection destination access point, the processing proceeds to step S905.

In step S905, the CPU 312 determines whether a security method is included in the information of the connection destination access point received from the information processing apparatus 200. If it is determined that a security method is not included in the information of the connection destination access point, in step S902 the CPU 312 terminates the DPP waiting mode and terminates the WEC connection determination processing of FIG. 9. Meanwhile, if it is determined that a security method is included in the information of the connection destination access point, the processing proceeds to step S906.

In step S906, the CPU 312 determines whether a password is included in the information of the connection destination access point received from the information processing apparatus 200. If it is determined that a password is not included in the information of the connection destination access point, in step S902 the CPU 312 terminates the DPP waiting mode and terminates the WEC connection determination processing of FIG. 9. Meanwhile, if it is determined that a password is included in the information of the connection destination access point, the processing proceeds to step S907.

In step S907, the CPU 312 terminates the DPP waiting mode. After terminating the DPP waiting mode, the CPU 312 cannot respond to DPP Authentication Requests from the information processing apparatus 200.

Then, in step S908, the CPU 312 terminates the network setup mode. In conjunction with termination of the network setup mode, the processing for disconnecting a P2P connection between the communication apparatus 300 and the information processing apparatus 200 is executed. The P2P connection disconnection processing may be processing for disconnecting P2P (WLAN) connection, which is defined by IEEE 802.11.

After the network setup mode is terminated, in step S909 the CPU 312 discards (deletes, erases, clears) the internally-held WEC-related information. If DPP Authentication is executed with the information processing apparatus 200 using the discarded WEC-related information, authorization fails. In that case, by DPP Authentication being executed with the information processing apparatus 200 using WEC-related information generated anew in step S803, authorization succeeds. If code information based on discarded WEC-related information is displayed in step S803, the display of the code information is stopped due to the discarding of the WEC-related information in step S909.

In the present embodiment, the WEC-related information is discarded after the network setup mode is terminated. However, the WEC-related information is not used after the DPP Authentication processing, and so, it may be discarded at a desired timing after the DPP Authentication processing has been terminated. Then, in step S910, the CPU 312 connects with the access point 400, using the SSID, the security method, and the password of the information of the connection destination access point received from the information processing apparatus 200. This connection is a connection that complies with an IEEE802.11 standard or a connection that uses DPP. Then, the WEC connection determination processing of FIG. 9 is terminated.

As described above, according to the present embodiment, the WEC-related information is discarded after the DPP Authentication processing, and so, it is possible to update the key pair at relatively small intervals and further improve security.

Further, in the present embodiment, description has been given assuming that the DPP waiting mode is terminated if determination conditions of steps S901 to S906 are not satisfied. A configuration may be taken so as to discard the internally-held WEC-related information at that time. Further, a configuration may be taken so as to determine in step S910 whether connection with the access point 400 has been successful or unsuccessful. A configuration may be taken so as to then discard the internally-held WEC-related information if it is determined that connection with the access point 400 has been unsuccessful.

### Second Embodiment

A second embodiment will be described below with respect to points different from the first embodiment. In the present embodiment, the WEC-related information is discarded when a timer for discarding the WEC-related information expires or the WFD mode is terminated.

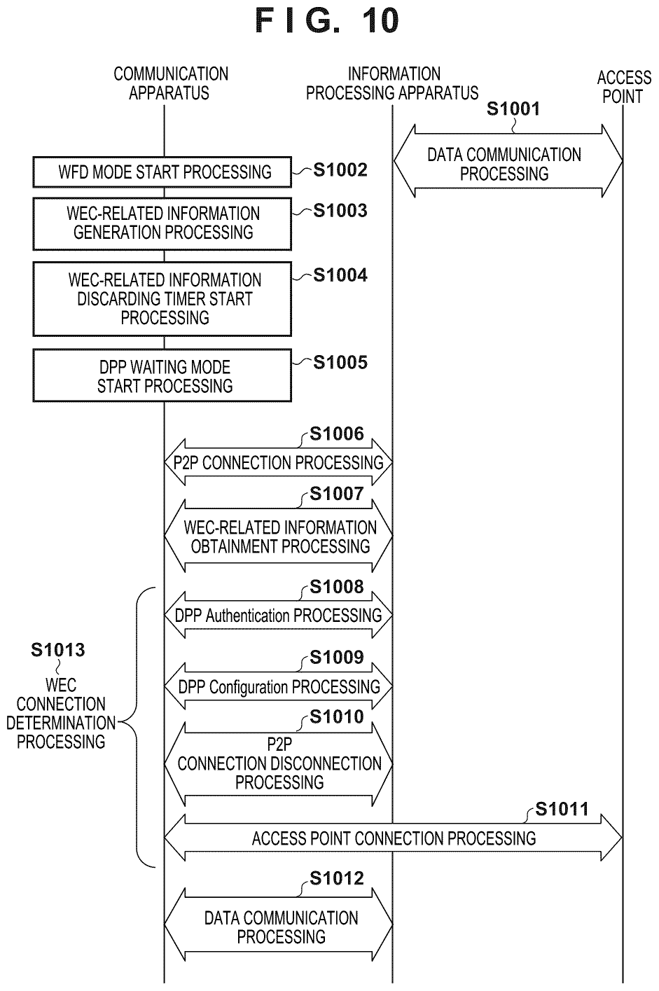

FIG. 10 is a diagram illustrating an example of a sequence for performing network setup according to WEC. The processing of each apparatus of FIG. 10 is realized, for example, by the CPU of each apparatus reading a program stored in the ROM out to the RAM and executing it.

In the present embodiment, assume that, before the sequence of FIG. 10 is started, the information processing apparatus 200 already holds communication parameters for connecting and communicating with a wireless infrastructure network formed by the access point 400. That is, in step S1001, the information processing apparatus 200 performs processing for performing data communication with another apparatus via the access point 400.

In step S1002, the communication apparatus 300 starts the WFD mode. A trigger for starting the WFD mode is not limited to a WEC setup start instruction according to user operation, and a trigger may be, for example, the start of a processing sequence for performing initial settings from a factory shipment state (arrival state) when the user turns on the power for the first time.

In step S1003, the communication apparatus 300 performs WEC-related information generation processing. The WEC-related information includes, for example, identification information (e.g., MAC address) of the communication apparatus 300, public key information used for performing secure communication between the communication apparatus 300 and the information processing apparatus 200, and the like. In the present embodiment, the communication apparatus 300 generates a QR code based on the WEC-related information and displays it on the operation display unit 305, for example.

Next, in step S1004, the communication apparatus 300 performs processing for starting a timer for discarding the internally-held WEC-related information. The timer for discarding the WEC-related information is a timer for discarding the internally-held WEC-related information according to a timeout occurring. In step S1004, the timer is started by setting a predetermined period of time designated as a time limit for the WEC-related information. The timer for discarding the WEC-related information may measure the time based on a hardware timer or may measure the time based on a software timer.

Then, in step S1005, the communication apparatus 300 executes DPP waiting mode start processing. That is, the CPU 312 causes the communication apparatus 300 to transition to the DPP waiting mode. In step S1005, the CPU 312 determines a DPP communication waiting channel and causes the communication apparatus 300 to start operation in the DPP waiting mode. This makes it possible to communicate using DPP with an external apparatus, such as the information processing apparatus 200. Which channel to use as the DPP communication waiting channel may be set by the user from an operation screen of the communication apparatus 300, for example.

Description for steps S1006 to S1012 will be omitted as it is the same as the description for steps S805 to S811 of FIG. 8.

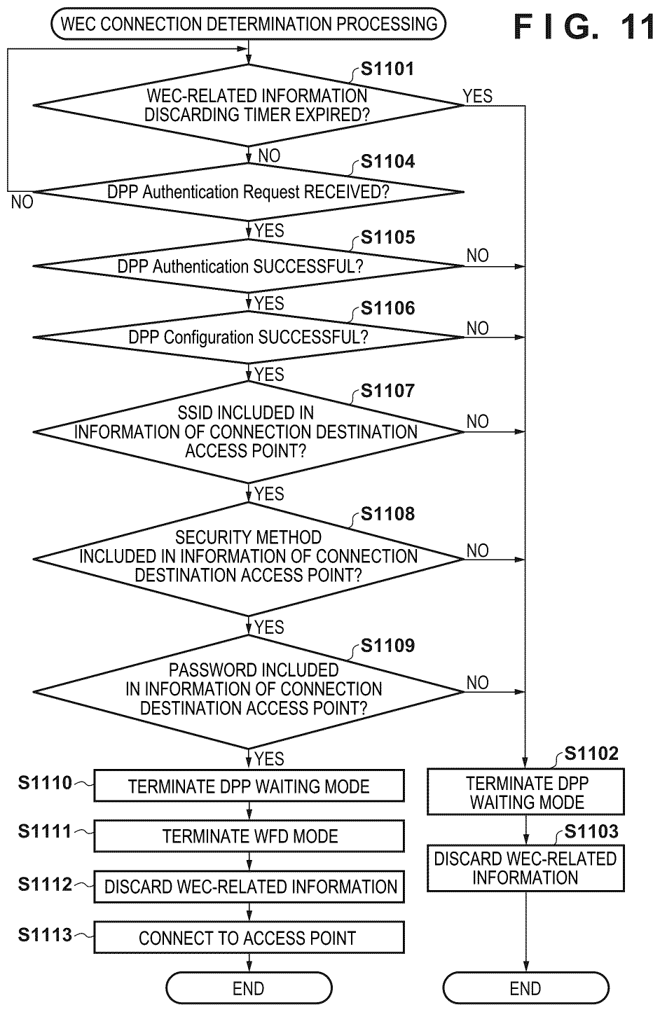

FIG. 11 is a flowchart illustrating the processing of steps S1008 to S1011 (WEC connection determination processing (step S1013)) of FIG. 10. The processing of FIG. 11 is realized, for example, by the CPU 312 reading a program stored in the ROM 313 out to the RAM 314 and executing it.

In step S1101, the CPU 312 determines whether the timer for discarding the internally-held WEC-related information has elapsed for the predetermined period of time designated as the time limit for the WEC-related information. If it is determined that the timer has expired, in step S1102 the CPU 312 terminates the DPP waiting mode. Then, in step S1103, the CPU 312 discards the internally-held WEC-related information and then terminates the WEC connection determination processing of FIG. 11. Configuration may be taken such that, when discarding the WEC-related information, only the key information necessary for DPP Authentication in the WEC-related information is discarded. Meanwhile, if it is determined that the timer has not expired, the processing proceeds to step S1104. If code information based on discarded WEC-related information is displayed in step S1003, the display of the code information is stopped due to the discarding of the WEC-related information in step S1103.

In step S1104, the CPU 312 determines whether a DPP Authentication Request has been received from the information processing apparatus 200. Here, if it is determined that a DPP Authentication Request has been received, the processing proceeds to step S1105. Meanwhile, if it is determined that a DPP Authentication Request has not been received, the processing is repeated from step S1101.

That is, in the present embodiment, if a DPP Authentication Request has not been received before the timer for discarding the WEC-related information has elapsed for the predetermined period of time, the internally-held WEC-related information is discarded. For example, it is expected that network setup according to WEC is aborted on the information processing apparatus 200 side. In that case, it not desirable in terms of security for the communication apparatus 300 side to continue displaying a QR code or the like that is based on the WEC-related information. In the present embodiment, if a DPP Authentication Request has not been received even if the predetermined period of time has elapsed, the internally-held WEC-related information is discarded, and thereby, it is possible to prevent a deterioration in security.

In step S1105, the CPU 312 determines whether processing for DPP Authentication with the information processing apparatus 200 has been successful. Regarding step S1105, description is the same as that for step S901. If it is determined that DPP Authentication processing has been unsuccessful, the processing proceeds to step S1102. Meanwhile, if it is determined that DPP Authentication processing has been successful, the processing proceeds to step S1106.

In step S1106, the CPU 312 determines whether processing for DPP Configuration with the information processing apparatus 200 has been successful. Regarding step S1106, description is the same as that for step S903. If it is determined that DPP Configuration processing has been unsuccessful, the processing proceeds to step S1102. Meanwhile, if it is determined that DPP Configuration processing has been successful, the processing proceeds to step S1107.

If DPP Configuration processing has been successful, the CPU 312 obtains information of the access point 400, which is set as a target of setting according to WEC.

In step S1107, the CPU 312 determines whether an SSID is included in the information of the connection destination access point received from the information processing apparatus 200. Regarding step S1107, description is the same as that for step S904. If it is determined that an SSID is not included in the information of the connection destination access point, the processing proceeds to step S1102. Meanwhile, if it is determined that an SSID is included in the information of the connection destination access point, the processing proceeds to step S1108.

In step S1108, the CPU 312 determines whether a security method is included in the information of the connection destination access point received from the information processing apparatus 200. Regarding step S1108, description is the same as that for step S905. If it is determined that a security method is not included in the information of the connection destination access point, the processing proceeds to step S1102. Meanwhile, if it is determined that a security method is included in the information of the connection destination access point, the processing proceeds to step S1109.

In step S1109, the CPU 312 determines whether a password is included in the information of the connection destination access point received from the information processing apparatus 200. Regarding step S1109, description is the same as that for step S906. If it is determined that a password is not included in the information of the connection destination access point, the processing proceeds to step S1102. Meanwhile, if it is determined that a password is included in the information of the connection destination access point, the processing proceeds to step S1110.

In step S1110, the CPU 312 terminates the DPP waiting mode. After terminating the DPP waiting mode, the CPU 312 cannot respond to DPP Authentication Requests from the information processing apparatus 200.

In step S1111, the CPU 312 terminates the WFD mode. In conjunction with termination of the WFD mode, the processing for disconnecting a P2P connection between the communication apparatus 300 and the information processing apparatus 200 is executed. The P2P connection disconnection processing may be processing for disconnecting a P2P (WLAN) connection defined by IEEE 802.11.

After the WFD mode is terminated, in step S1112 the CPU 312 discards (deletes, erases, clears) the internally-held WEC-related information. If DPP Authentication is executed using the discarded WEC-related information, authorization fails. In that case, by DPP Authentication being executed with the information processing apparatus 200 using WEC-related information generated anew in step S1003, authorization succeeds.

Then, in step S1113, the CPU 312 connects with the access point 400, using the SSID, the security method, and the password of the information of the connection destination access point received from the information processing apparatus 200. This connection is a connection that complies with an IEEE802.11 standard or a connection that uses DPP. Then, the WEC connection determination processing of FIG. 11 is terminated.

As described above, according to the present embodiment, the WEC-related information is discarded when the timer has elapsed for the predetermined period of time and so, and so, it is possible to update the key pair at relatively small intervals and further improve security. Further, a configuration may be taken so as to determine in step S1113 whether connection with the access point 400 has been successful or unsuccessful. A configuration may be taken so as to then discard the internally-held WEC-related information if it is determined that connection with the access point 400 has been unsuccessful.

### Other Embodiments

Various embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-088071, filed May 29, 2023, which is hereby incorporated by reference herein in its entirety.

What is claimed is:

1. A communication apparatus capable of communicating with an information processing apparatus, the communication apparatus comprising:
at least one memory and at least one processor which function as:
a holding control unit configured to perform control such that a holding unit holds information to be used for communication for establishing a wireless connection according to a first connection method between an external access point and the communication apparatus, the external access point being different from both the information processing apparatus and the communication apparatus;
a reception control unit configured to perform control so as to receive a request transmitted from the information processing apparatus based on the held information;
a communication control unit configured to perform control so as to execute communication for establishing the wireless connection according to the first connection method based on the request received by the reception control unit; and
a discarding control unit configured to perform control so as to discard the information held in the holding unit based on the reception control unit having received the request.

2. The communication apparatus according to claim 1,
the at least one processor further functioning as:
a generation control unit configured to perform control so as to generate the information,
wherein the holding unit holds the information generated by the generation control unit.

3. The communication apparatus according to claim 1, wherein
in a case where the request is not received by the reception control unit, the discarding control unit further performs control so as to discard the information held in the holding unit based on a predetermined period of time having elapsed.

4. The communication apparatus according to claim 1, wherein
in a case where the communication executed by the communication control unit has failed, the discarding control unit further performs control so as to discard the information held in the holding unit.

5. The communication apparatus according to claim 1, wherein
in the communication executed by the communication control unit, a communication parameter is communicated between the communication apparatus and the information processing apparatus, and the information is information used for encrypting the communication parameter.

6. The communication apparatus according to claim 5, wherein
the information used for encrypting the communication parameter includes a public key.

7. The communication apparatus according to claim 5, wherein
in a case where the communication parameter obtained from the information processing apparatus in the communication executed by the communication control unit does not satisfy a condition, the discarding control unit further performs control so as to discard the information held in the holding unit.

8. The communication apparatus according to claim 7, wherein
the condition is that the communication parameter includes predetermined information.

9. The communication apparatus according to claim 8, wherein
the predetermined information is a service set identifier (SSID) of the external access point.

10. The communication apparatus according to claim 8, wherein
the predetermined information is information of a security method of the external access point.

11. The communication apparatus according to claim 8, wherein
the predetermined information is a password of the external access point.

12. The communication apparatus according to claim 5, wherein
the communication executed by the communication control unit is communication executed according to Device Provisioning Protocol (DPP).

13. The communication apparatus according to claim 12, wherein
the discarding control unit performs control so as to discard the information after a mode started by the DPP is terminated, the mode being a mode in which execution of communication based on the information is awaited.

14. The communication apparatus according to claim 1, wherein
the holding unit holds the information so as to be obtainable by the information processing apparatus.

15. The communication apparatus according to claim 14, wherein
the holding unit holds the information as information that can be imaged by the information processing apparatus.

16. The communication apparatus according to claim 15, wherein
the information that can be imaged is code information displayed on a display unit.

17. The communication apparatus according to claim 16, wherein
by the discarding control unit discarding the information held in the holding unit, control is performed so as to stop display of the code information.

18. The communication apparatus according to claim 1,
the at least one processor further functioning as:
a control unit configured to control the communication apparatus so as to allow reception of the request by the reception control unit,
wherein in a case where transition to a state in which a wireless connection according to a second connection method between the information processing apparatus and the communication apparatus is started, the wireless connection according to the second connection method not going through the external access point, the control unit controls the communication apparatus so as to allow reception of the request.

19. The communication apparatus according to claim 18, wherein
the wireless connection according to the second connection method is a wireless connection according to peer-to-peer between the information processing apparatus and the communication apparatus.

20. The communication apparatus according to claim 19, wherein
the wireless connection according to the second connection method is a wireless connection in which the communication apparatus is an access point between the information processing apparatus and the communication apparatus.

21. The communication apparatus according to claim 1, wherein
the communication apparatus is a printer.

22. A method to be executed in a communication apparatus capable of communicating with an information processing apparatus, the method comprising:
performing control such that a holding unit holds information to be used for communication for establishing a wireless connection according to a first connection method between an external access point and the communication apparatus, the external access point being different from both the information processing apparatus and the communication apparatus;
performing control so as to receive a request transmitted from the information processing apparatus based on the held information;
performing control so as to execute communication for establishing the wireless connection according to the first connection method based on the received request; and
performing control so as to discard the information held in the holding unit based on the request having been received.

23. A non-transitory computer-readable storage medium storing one or more programs configured to cause one or more computers of an information processing apparatus to function as:
a holding control unit configured to perform control such that a holding unit holds information to be used for communication for establishing a wireless connection according to a first connection method between an external access point and the communication apparatus, the external access point being different from both the information processing apparatus and the communication apparatus;
a reception control unit configured to perform control so as to receive a request transmitted from the information processing apparatus based on the held information;
a communication control unit configured to perform control so as to execute communication for establishing the wireless connection according to the first connection method based on the request received by the reception control unit; and
a discarding control unit configured to perform control so as to discard the information held in the holding unit based on the reception control unit having received the request.
